(19) United States
(12) Patent Application Publication
(10) Pub. No.: US 2002/0069691 A1
(43) Pub. Date: Jun. 13, 2002

(54) Low volume vacuum source for leak test fixture

(76) Inventors: Daryl L. Roberts, Blaine, MN (US); Virgil A. Marple, Maple Plain, MN (US)

Correspondence Address: WESTMAN, CHAMPLIN & KELLY, P.A., International Centre - Suite 1600, 900 Second Avenue South, Minneapolis, MN, 55402-3319, US

(21) Appl. No.: 09/733,115

(22) Filed: Dec. 8, 2000

(51) Int. Cl. G01M 3/08

(52) U.S. Cl. 73/46

(57) ABSTRACT

A low volume vacuum source that utilizes a mechanical vacuum generating device. In particular, a syringe is used as a vacuum source and is connected through a check valve to a test fixture of a cascade impactor that is used for classifying particles. The test fixture has fluid passageways that seal onto the chambers of the compactor, and by pulling and retracting the syringe piston, the vacuum is generated in the test fixture. The vacuum level is measured with a gauge. A check valve in the syringe outlet line prevents bleed back of the vacuum once vacuum has been formed. A separate bleed valve can be opened for relieving the vacuum applied to the test fixture.

### CROSS REFERENCE TO RELATED APPLICATIONS

Reference is made to U.S. patent application Ser. No. 09/679,936, filed Oct. 5, 2000, for METHOD AND APPARATUS FOR CASCADE IMPACTOR TESTING OF INHALABLE DRUG THERAPIES RECOVERY FOR CHEMICAL ANALYSIS.

### BACKGROUND OF THE INVENTION

The present invention relates to a low cost, efficient, vacuum source for a test fixture to test the integrity of seals, primarily in cascade impactors, to insure that the seals are adequately enclosing the impactor chambers.

In the prior art, the use of cascade impactors has been well known. In particular, application Ser. No. 09/679,936, filed Oct. 5, 2000, shows a cascade impactor that is used specifically for inhalable drug therapies. In order to obtain accurate results, at relatively low volumes that are involved in such impactors, it is essential to know that the seals that seal individual impaction chambers are secure or have integrity. A test fixture that is used can be for determining pressure drop across individual chambers, or for determining the flow rate of fluid through the system. A test fixture is shown in U.S. patent application Ser. No. ______, filed on even date herewith entitled METHOD AND APPARATUS FOR VERIFYING INTEGRITY OF CASCADE IMPACTORS, (attorney's docket M419.12-0023), which is incorporated by reference.

The present vacuum source is an easily used, low cost source that can be utilized with such relatively low volume impactors to determine any leakage of seals in a simple, efficient, and very rapid manner.

### SUMMARY OF THE INVENTION

The present invention relates to a vacuum source for use with a sealable chamber to provide a single vacuum loading. The vacuum source utilizes existing components in a simple, low cost manner. The vacuum source has a connection to a test fixture, in the exemplary form, and includes a manual operated plunger in a cylinder, as shown in a syringe of a suitable volume, for example about 50 cubic centimeters. The syringe, or other manually plunger operated piston, is mounted in a cabinet or housing.

The cylinder is connected through a check valve that will prevent fluid leakage from the cylinder so the vacuum created will not leak. The line that leads from the cylinder is connected through a four-way coupler to a vacuum gauge of conventional design, that will indicate the vacuum level. The gauge also will indicate leakage if the vacuum leaks. This coupler also connects a line leading to the chamber being checked for leaks, which is intended to be a test fixture. A line leading to a bleed valve is also connected through a coupler so that the vacuum can be bled off easily.

The system is thus very simple, and can be manually operated to generate a vacuum for low volume chambers to test leakage of seals sealing such chambers.

### BRIEF DESCRIPTION OF THE DRAWINGS

FIG. 1 is a front elevational view of a typical cabinet having a vacuum source made according to the present invention installed therein;

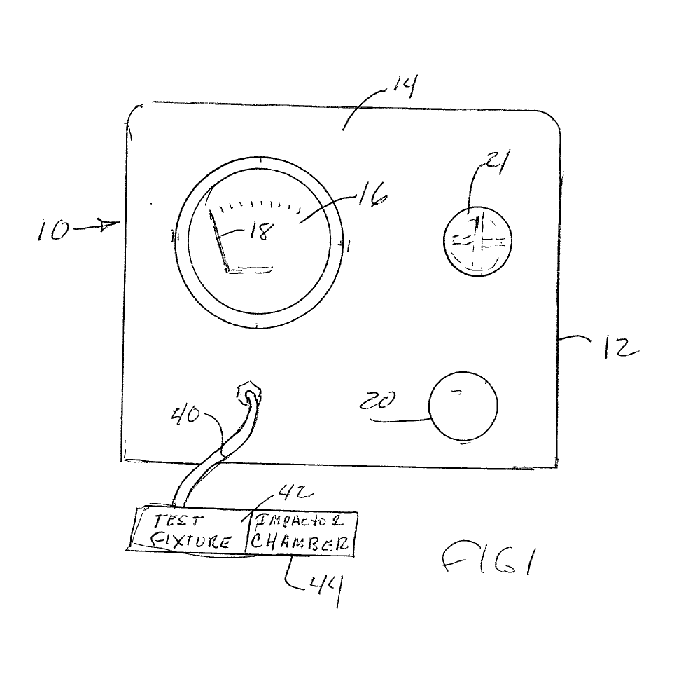

FIG. 2 is a side view of the interior of the cabinet showing a syringe that forms a vacuum source, and associated connections; and

FIG. 3 is a schematic drawing of the vacuum source of the present invention.

### DETAILED DESCRIPTION OF THE EXEMPLARY EMBODIMENT

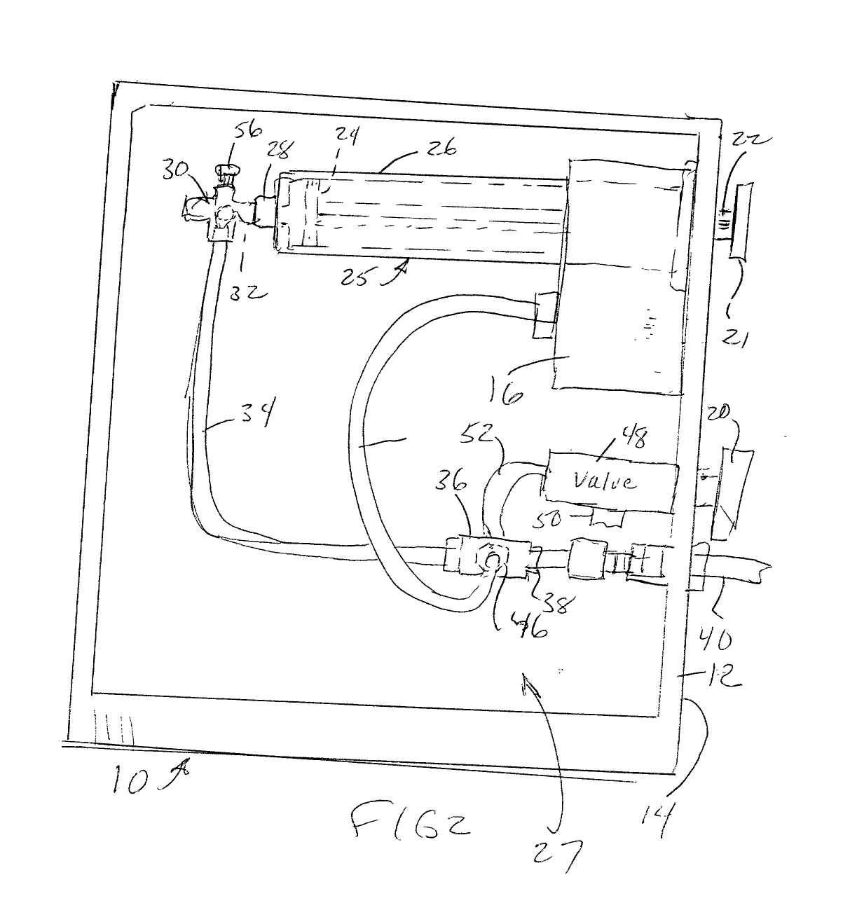

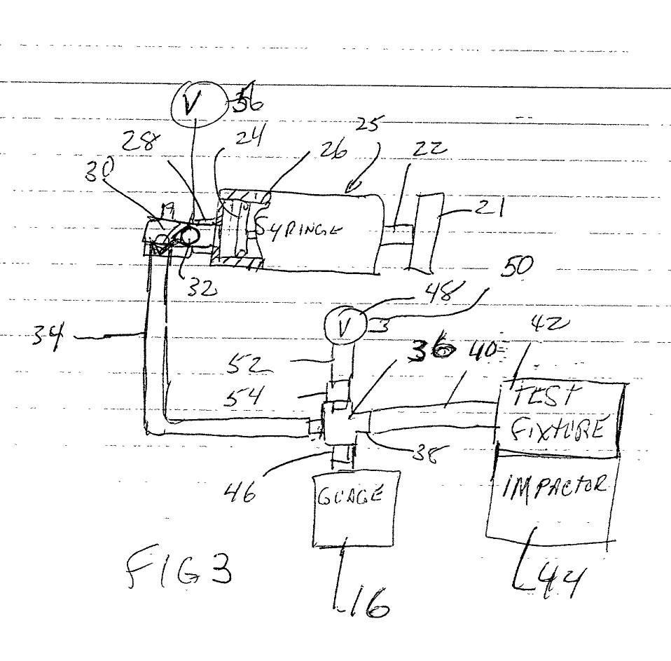

A vacuum source assembly indicated generally at 10 comprises a cabinet 12 that has a front panel 14. The front panel 14 mounts a vacuum gauge 16, that has a dial face, as shown, with an indicator needle 18 indicating the amount of vacuum at the input of the gauge. The front panel 14 further includes a manual bleed valve actuator 20, and a handle 21 that is connected to a piston for generating a vacuum by extending the handle. The handle 21 is connected to a shaft 22 that moves a piston 24 on the interior of a cylinder or barrel 26 (see FIGS. 2 and 3). As shown, the barrel 26, the piston 24, the shaft 22 and the handle 21 are part of a syringe 25 that is of suitable size for generating the amount of vacuum that is desired. The syringe 25, vacuum gauge 16 and other components are in an interior chamber 27 of the cabinet 12. The syringe 25 and vacuum gauge 16 are fixedly mounted on an interior side of the front panel 14. The syringe has an outlet fitting 28 that is connected to a check valve assembly 30.

The check valve 32 in the assembly 30 is made so that fluid can be drawn into the interior of barrel 26 of the vacuum generating cylinder, but the check valve 32 will prevent reverse flow of fluid from the cylinder. The check valve 32 is connected to a vacuum line 34 which leads to a four-way connector 36. The four way connector 36 is a parallel passageway housing that has an inlet and three outlets. One of the outlets is shown at 38 and connects through a line 40 to a test fixture 42 that is to be tested for leakage. The test fixture is mounted over sealed chambers, for example the chambers of an impactor represented at 44. The impactor can be of any desired type, but usually is a cascade impactor that has rubber “O” ring seals on it to seal passageways, such as shown in the previously mentioned application Ser. No. 09/697,936, filed Oct. 5, 2000.

A further branch of the connector 34, which is shown at 46 is connected to the vacuum gauge 16, so that any vacuum that is generated in line 34 will change the reading at the gauge 16. Additionally, a bleed valve 48 that discharges to the atmosphere through an outlet 50 is connected with a line 52 to an outlet of the connector 36. The actuator 20 operates the bleed valve.

Relatively low cost components, and mounting them in a common housing or frame 12, are used so a low volume vacuum can be generated merely by pulling on the handle 21 of the syringe, moving the piston and generating a vacuum in the interior of the barrel 26, which is carried through the line 34 to the four-way connector 36. This then provides a vacuum through line 40 to the test fixture 42 and subjects the chambers of the impactor 44 that are open to the test fixture to a vacuum for testing. The gauge 16 records the amount of vacuum that is generated and shows a change if the seals on the test chamber leak.

In most tests, a one minute test under vacuum is used for insuring the integrity of the seals of an impactor. If the gauge does not indicate a drop in vacuum below a prescribed amount, after the allotted time has passed, it is known that the test fixture is sealed tightly on the impactor. The test fixture then can be used for things such as determining the flow rate, pressure drop across components and other test functions that are desired for the impactor.

When the test is done, the valve 48 is opened and atmospheric pressure is provided to the system. The piston 24 can be returned to its original position adjacent the outlet 28, by opening a bleed valve illustrated schematically at 56 that opens between the check valve 32 and the barrel of the syringe.

Although the present invention has been described with reference to preferred embodiments, workers skilled in the art will recognize that changes may be made in form and detail without departing from the spirit and scope of the invention.

What is claimed is:

1. A manual vacuum source comprising a housing, a cylinder supported in said housing, a piston on the interior of said cylinder that is manually operated to generate a vacuum at an outlet of the cylinder, a connection from the outlet of the cylinder to a sealed chamber for providing a manually generated vacuum at the chamber by retracting the piston in the cylinder.

2. The vacuum source of claim 1, wherein said cylinder and piston comprise a syringe.

3. The vacuum source of claim 1 and a check valve at the outlet of the syringe oriented to prevent fluid from the syringe from bleeding back through the outlet of the syringe.

4. The vacuum source of claim 3 and an outlet line on an outlet of the check valve that carries vacuum formed in the barrel of the cylinder, a vacuum level indicator, a connector manifold having a first connection connected to, and the outlet line having second and third connections connected to the chamber and the vacuum gauge.

5. The vacuum source of claim 4 and a bleed valve connected to a fourth outlet of the connector operable to relieve the vacuum in the outlet vacuum line.

6. The vacuum source of claim 1, wherein said chamber comprises a test fixture sealingly attached to a cascade impactor for testing seals between the test fixture and the impactor.
